(19) United States
(12) Patent Application Publication
(10) Pub. No.: US 2016/0337435 A1
(43) Pub. Date: Nov. 17, 2016

(54) ORDERING EVENTS WITH ALTERNATING EPOCHS OF EVENT IDENTIFIERS

(71) Applicant: LinkedIn Corporation, Mountain View, CA (US)

(72) Inventors: Abhishek Nigam, San Jose, CA (US); Mayuresh R. Gharat, Mountain View, CA (US)

(73) Assignee: LinkedIn Corporation, Mountain View, CA (US)

(21) Appl. No.: 14/712,659

(22) Filed: May 14, 2015

(51) Int. Cl. H04L 29/08

(52) U.S. Cl. CPC H04L 67/02; H04L 67/142; H04L 67/327

(57) ABSTRACT

A system, method, and apparatus are provided for identifying and/or ordering events (or notifications of events) within a computing environment featuring a high rate of events (e.g., hundreds of millions per minute). New events are labeled based on multiple alternating epochs comprising sequences of event identifiers, wherein each epoch's identifiers are mutually exclusive of other epochs. Illustratively, each epoch may commence with a different initial identifier (e.g., 0, 1, 2) and each epoch's sequence of identifiers thereafter increment in the same manner (e.g., by twos, by threes) until a maximum identifier is encountered. All of one epoch's identifiers are applied before the next epoch's are applied. After a last epoch is exhausted, labeling begins again with the first epoch. Verifying or enforcing event ordering may involve determining a given event's identifier, epoch, timestamp, and/or other characteristics, and/or characteristics of a previous event.

### BACKGROUND

This disclosure relates to the field of computers. More particularly, a system, method, and apparatus are provided for ordering events using alternating epochs of event identifiers.

Some computing environments feature extremely high rates of notable events. For example, in a professional network or social network system, individual events may involve actions associated with content items (e.g., posting, opening, serving, sending, or otherwise interacting with an item), clicking on a control, generating a message, editing a profile, and so on, and may be produced at a rate of millions of events per minute or higher (e.g., hundreds of millions, billions).

In this type of environments, and other, it may be desirable to identify events with sequence numbers or other identifiers, for the purpose of tracking them (and/or follow-on activity), ordering them, performing error-checking, and/or other purposes. If a single set or sequence of numbers or other identifiers is used to identify them, these identifiers will be exhausted in rather short order, thus requiring frequent reuse of the same identifiers.

In addition, depending on the rate at which events are produced and the number of identifiers, it may be uncertain whether an event having a given identifier refers to a relatively recent event that occurred during a current iteration of the set of identifiers or to an older event that occurred during a previous iteration of the identifiers. The smaller the set of identifiers, and the higher the rate at which events are produced, the more acute this problem may be.

Yet further, because events are generated continuously and extremely frequently in this type of environment, there is a need to limit the amount of overhead processing required to apply and examine identifiers. A fixed allocation scheme, wherein a limited number of identifiers is allocated and then all identifiers are examined or verified after they are used and before another set of identifiers is allocated would require too much overhead processing and could impact system operation.

### DESCRIPTION OF THE FIGURES

FIG. 1 is a block diagram depicting a system in which alternating epochs of identifiers are used to identify events within a computing environment, in accordance with some embodiments.

FIG. 2 is a flow chart illustrating a method of using alternating epochs of identifiers to identify events within a computing environment, in accordance with some embodiments.

FIG. 3 depicts an apparatus that uses alternating epochs of identifiers to identify events within a computing environment, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, method, and apparatus are provided for identifying events within a computing environment marked by the production of prodigious numbers of events—on the order of hundreds of millions of events per minute, for example. The events may pertain to (or be caused by) internal system activity, activity by users of the system, and/or other activity. Each event may be transmitted or conveyed, along with its identifier and/or other information, for further processing by one or more entities (e.g., event consumers), which may verify and/or enforce correct ordering of events.

In these embodiments, multiple epochs of identifiers (i.e., two or more) are employed for identifying events (or messages conveying events or notifications of events). The identifiers of a given epoch comprise an increasing (or decreasing) sequence of integers (or other types of numbers), and each epoch's sequence of integer identifiers is unique in comparison to those of other epochs. Identifiers of a first epoch are assigned in order to events, followed by identifiers of another epoch, and so on. After all epochs' identifiers have been used, the process restarts with the first epoch.

Because the epochs' identifiers are mutually exclusive, the value of a given identifier automatically identifies its epoch, and an event consumer (or other entity that examines an event) will easily recognize an event belonging to a previous epoch (i.e., an event having an identifier assigned in a previous epoch). In contrast, in a system in which a single set of sequence numbers is applied over and over again, an event having a particular sequence number may be fresh (i.e., part of a current iteration of the sequence numbers) or old (i.e., part of a previous iteration of the sequence numbers), and some additional processing may be required to determine which.

In computing environments described herein, with immense numbers of events to process, the easier and faster it is to determine whether a given event (or event identifier) is out of order, the better. Because these computing environments may feature operation of an online service or application that operates continually, the numbering of events must proceed without delay, and therefore static schemes in which a limited number of identifiers are allotted and then verified before another allotment is provided, is untenable. The event-numbering scheme must operate continually, without delay, and the use of multiple, mutually exclusive epochs of event identifiers supports this requirement while also providing for smooth transition from one epoch to another.

To help in the labeling/identification of events, and/or the examination or verification of event ordering, pointers, flags, variables, and/or other references may be used to track epochs (e.g., past epoch, current epoch, next epoch) and/or event identifiers (e.g., the last identifier used, the current or expected identifier). As described below, timestamps may also be applied to events and used to verify or enforce ordering, but multiple different events may have the same timestamp due to the rapid event rate.

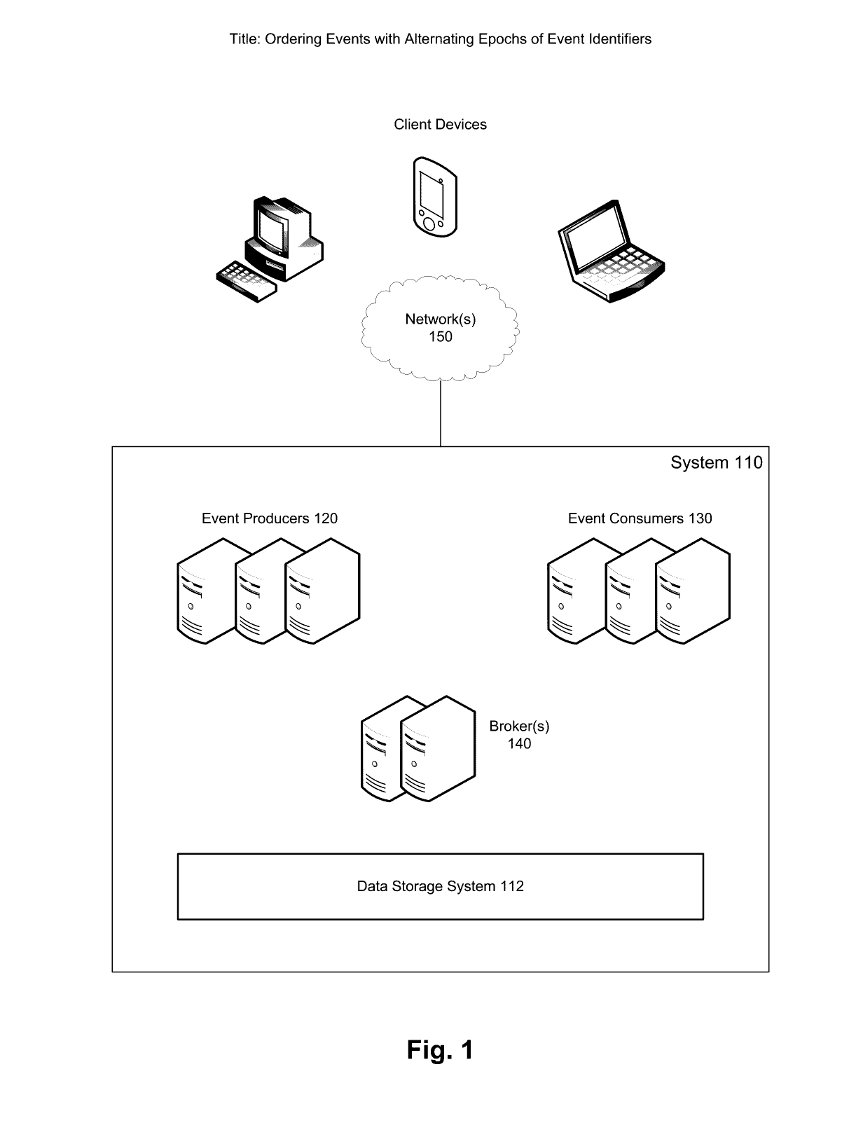

FIG. 1 is a block diagram depicting a system in which alternating epochs of identifiers are used to identify events within a computing environment, according to some embodiments. In these embodiments, the events may reflect activity completely contained within the system, activity that involves interaction between the system and an external entity (e.g., a user, a 3^{rd} party system), and/or external activity of which the system is advised or notified. Individual events may therefore be spawned by any type of activity or interaction described herein, as well as other type of activities and interactions that occur in association with an online application or service.

System 110 of FIG. 1 is (or is part of) a data center that supports or hosts an online application or service that features a community or network of users, such as a professional network or a professional social network offered by LinkedIn® Corporation. Users of system 110 may be termed members, and may be required to register with the system in order to use the application or service, or some feature(s) of the application or service. Members may be identified and differentiated by username, electronic mail address, telephone number, and/or some other unique identifier.

Users/members of a service or services hosted by system 110 connect to the system via client devices, which may be stationary (e.g., desktop computer, workstation) or mobile (e.g., smart phone, tablet computer, laptop computer). In order to interact with the system (e.g., to view content, submit or edit content) the client devices operate suitable client applications, such as a browser program or an application designed specifically to access a service offered by system 110. In addition, other communication software (e.g., electronic mail, instant messaging) may be executed by a client device in order to communicate with system 110.

Client devices are coupled to system 110 via direct channels and/or one or more networks 150 or other shared channels, which may include the Internet, intranets, and/or other networks, and may incorporate wired and/or wireless communication links.

Via the client devices and the applications they execute, members are able to submit information to system 110, receive information submitted by other members, exchange messages with other members, and otherwise interact within the community. Various mechanisms or functions may be offered by system 110 to promote such information exchange, to allow members to “share,” “post,” or “like” some particular content, to comment upon or forward the content, to upload or create a link to content, to connect to or to follow another member, to subscribe to content channels, to make and receive endorsements and recommendations, and so on.

Interactive user/member sessions with system 110 are generally made through a portal, which may comprise a web server, an application server, and/or some other gateway or entry point. The portal through which a given session is established may depend on the member's device or method of connection. For example, a user of a mobile client device may connect to system 110 via a different portal (or set of portals) than a user of a desktop or workstation computer.

System 110 includes data storage system 112, which may be a distributed data storage system. Data storage system 112, and/or components of the data storage system (e.g., separate storage engines), include appropriate data storage devices (e.g., disks, solid-state drives) and store data used by components of system 110, possibly including some or all events reported by producers 120 and consumed by consumers 130.

System 110 also includes event producers 120, event consumers 130, and one or more optional brokers 140. Briefly, an event producer is an entity that produces or initiates events, and an event consumer is an entity that receives events (or notifications of events) and that may act upon an event and/or take some action in response to an event (e.g., which may spawn another event). A broker is an entity that transfers events from one or more event producers 120 to one or more event consumers 130, to ensure each consumer receives the events it needs and/or for other reasons. Event producers 120, event consumers 130, and brokers 140 may be or may be hosted by any number of computing machines.

In some embodiments, event producers 120 and/or event consumers 130 include multiple services or applications involved in the operation of system 110, some of which may interact with members of system 130, and some of which may not. For example, different services (event producers and/or consumers) may serve content to members, recommend content to serve to members, track/record activity of members, track activity within system 110, maintain member profiles, record member connections, report changes to system/user data, etc.

The types of services associated with event producers and event consumers may vary widely among different embodiments, but a common trait is that an event producer produces or reports discrete events, which are identified using multiple epochs of event identifiers (as described below), and an event consumer consumes one or more types of events or events having one or more particular attributes, parameters, or characteristics. A given event producer may also be an event consumer, and vice versa, and a broker may act as an event producer and/or an event consumer.

In some embodiments, a broker is an intermediate entity that receives events (or notifications of events) from producers and that delivers selected events to consumers. For example, a given event consumer may identify to a broker one or more types of events that it should receive. The broker may then identify corresponding events (e.g., from attributes or characteristics that accompany them), and make them available to the consumer. A given broker may receive events from any number of producers (i.e., one or more) and may provide events to any number of consumers.

In some other embodiments, a broker acts as a streaming data store and/or provides a logging or tracking function. For example, incoming events emitted by producers and received by a broker may be logged by that broker for some (configurable) period of time, during which they may be read from the broker's logs by consumers.

By way of example, services that operate within system 110 (and that may be event producers and/or event consumers) may include a profile service or server that maintains profiles of members of the service(s) hosted by system 110, which may be stored in data storage system 112 and/or elsewhere. An individual member's profile may include or reflect any number of attributes or characteristics of the member, including personal (e.g., gender, age or age range, interests, hobbies, member ID), professional (e.g., employment status, job title, job location, employer or associated organization, industry, functional area or role, skills, endorsements, professional awards, seniority), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify or characterize a member who shared or received information, to identify a member's level of proficiency within the community, to characterize content, to select content to serve to a member, to record a content-delivery event).

When a member updates his or her profile, the profile service may act as an event producer to report that event, which may be consumed by a service that acts upon the notification to, for example, notify another member of the profile update and/or store the update. The profile service may act as an event consumer at some other time to, for example, update one member's profile in response to receipt of an event reflecting or indicating acceptance of a connection request issued by the one member to another member.

Organizations may also be members of the service(s) offered by system 110 (i.e., in addition to individuals), and may have associated descriptions or profiles comprising attributes such as industry, size, location, goal or purpose, etc. An organization may be a company, a corporation, a partnership, a firm, a government agency or entity, a not-for-profit entity, a group or collection of associated members, or some other entity formed for virtually any purpose (e.g., professional, social, educational). Either or both organizations and individual members may “follow” and/or be followed by other members, may share and/or received shared information, may initiate and receive communications with other members, may post content and/or receive content posted by other members, etc.

Another illustrative service is a content service or server that maintains one or more repositories of content items for serving to members (e.g., within data storage system 112 and/or elsewhere), an index of the content items, and/or other information useful in serving content. Illustratively, a content service may serve on the order of hundreds of millions of content items or objects every day. A content store may include various types of sponsored and/or unsponsored content items for serving to members and/or for use by various components of system 110, which may be generated within the system or by external entities. A content service (or some other component of system 110) may include a recommendation module for recommending specific content to serve to a member.

A content service may be an event producer that produces or reports events relating to the serving of content items to members; these events may be consumed by a tracking service, for example. The content service may act as an event consumer to consume events such as requests for content and/or other activity and actions that require content to be served (e.g., when a member logs in).

A tracking service or server may monitor and record (e.g., within data storage system 112 and/or elsewhere) activity of system 110 and/or members. For example, whenever content or a communication is served by the system (e.g., to a client device), the tracking server may be informed of what is served, to whom (e.g., which member), when it was served, and/or other information. Similarly, the tracking server may also receive send and/or receive notifications of member actions regarding content actions and communications, to include identities of the member and the content acted upon, the action that was taken, when the action was taken, etc. Illustrative actions that may be captured include, but are not limited to, clicks/taps/pinches (on the content, on a logo or image), conversions, follow-on requests, visiting a page associated with a subject or provider of the content, taking some other action regarding the content (e.g., commenting on it, sharing it, following its provider, liking it), and so on.

Also, a tracking service or server, or some other service, may record members' interaction with or use of system services, to include dispatch or receipt of a communication (e.g., electronic mail, instant message, a post, a comment, a share, a recommendation, a connection request), alteration or completion of a member profile, uploading of a member's contacts, downloading an application or feature offered by system 110, subscription to a content channel, addition of a skill, sending or receiving an endorsement of a skill, etc.

A tracking service may therefore produce and/or consume events related to interaction between members and system 110 (or between members and content served by system 110).

A connection service or server may maintain members' connections with other members. Such connections may be stored as a graph, for example, in which different nodes represent different members and a link between two given nodes represents an explicit or implicit connection. An explicit connection may be formed when two members establish a formal connection (e.g., one of them accepts a connection request issued by the other); an implicit connection may be formed automatically when one member takes some action that involves another member (e.g., sends a communication, follows or subscribes to the other member, comments on a post or other content provided by the other user).

A connection service may thus produce and/or consume events indicating connection requests and/or created connections.

Members of a service hosted by system 110 have corresponding “home” pages (e.g., web pages, content pages) on the system, which they may use to facilitate their activities with the system and with each other, to form connections/relationships with other members, to view their connections and/or information regarding their connections, to view their goals and/or associated milestones, to review/modify their profiles, to inform friends and/or colleagues of developments in their lives/careers, to send/receive communications, etc. These pages (or information provided to members via these pages) are available to some or all other members. Members' home pages may be stored within data storage system 112 or elsewhere.

System 110 may include other components, services, servers, and/or other entities not illustrated in FIG. 1. Also, functionality attributed herein to system 110 may be distributed among its components in an alternative manner, such as by merging or further dividing functions of one or more components, or may be distributed among a different collection of components. Yet further, while depicted as separate and individual hardware components (e.g., computer servers) in FIG. 1, event producers 120, event consumers 130, and brokers 140 may alternatively be implemented as separate software modules executing on one or more computer servers. Thus, although only a single instance of a particular component of system 110 may be illustrated in FIG. 1, it should be understood that multiple instances of some or all components may be utilized.

In an illustrative embodiment, an event producer within system 110 alternates between two epochs, with one epoch comprising even integers (e.g., starting at 0 or 2) and the other epoch comprising odd integers (e.g., starting at 1), with both epochs' identifiers increasing in sequence. An event received out of order—within the correct epoch or from another epoch—can therefore be identified easily.

In another illustrative embodiment, three or more epochs may be employed, each one commencing with a different initial integer identifier (e.g., 0, 1, 2) and thereafter increasing in sequence by the same increment, so that each identifier is unique to one epoch. For example, with three epochs, one epoch may comprise identifiers 0, 3, 6, 9, . . . , a second epoch may comprise identifiers 1, 4, 7, 10, . . . , and a third epoch may comprise identifiers 2, 5, 8, 11, . . . .

The maximum identifier in an epoch may depend upon the hardware and/or software components that comprise or support an event producer. For example, the type of integer value used within the system and/or the event producer's platform (e.g., int or long or word, int64 or longword or quadword) may determine the maximum integer value, and the epochs' sequences of identifiers would end accordingly. Thus, one epoch's identifiers may terminate at the maximum integer value (e.g., 2ⁿ−1 for an unsigned integer n bits in size), another epoch may end at the maximum integer value minus one (e.g., 2ⁿ−2), and so on.

In some embodiments, each event producer maintains its own ordering and identification of events it produces and emits. Each event dispatched by a given producer may be consumed by any number of consumers, each of which will be able to verify the order of events received from that producer. Thus, multiple different producers may use the same identifiers and sequences of identifiers (in the same or different epochs), but they are applied independently by each producer, and each event may include an identity of the producer or some other information for distinguishing one stream of events from another. For example, different streams of events may be categorized into different “topics,” “classes,” “categories,” or other divisions, and include labels identifying their divisions.

In some other embodiments, a given producer may emit multiple streams of events (e.g., having different topics or divisions, of different types), in which case the producer orders/identifies events of each stream separately; each stream may employ the same or different event identifier epochs.

Some embodiments operate primarily to determine whether events (or event notifications/messages) are received in order. For example, an application, tool, or service that transmits, conveys, and/or delivers communications may be tested to determine whether those communications (e.g., events, event notifications) are received in-order at some end-point or intermediate destination (e.g., an event consumer, a broker). In these embodiments, each out-of-order receipt of a communication may be noted and may be used to evaluate and/or modify the communication scheme (or some component of the scheme).

Other embodiments operate to not only detect out-of-order receipt of a communication (e.g., an event or event notification), but also to re-order communications and/or take other error corrective action regarding them (e.g., request retransmission of a communication, delay processing of a communication to await an intervening delayed communication).

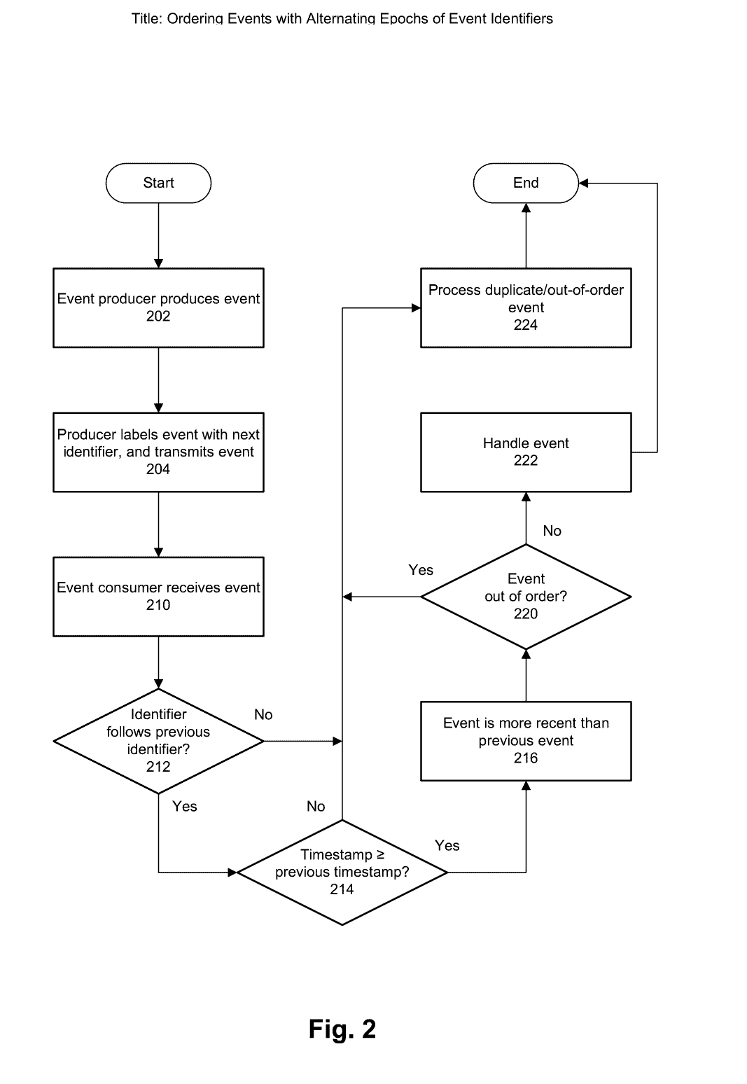

FIG. 2 is a flow chart illustrating a method of using alternating epochs of identifiers to identify events within a computing environment, according to some embodiments. In other embodiments, one or more of the illustrated operations may be omitted, repeated, and/or performed in a different order. Accordingly, the specific arrangement of steps shown in FIG. 2 should not be construed as limiting the scope of the embodiments.

In operation 202, an event producer produces or initiates an event in response to some member action, some action within the system, or some other occurrence. For example, in system 110 of FIG. 1, an event may be triggered every time the system receives a signal indicating a member has clicked on (or otherwise interacted with) electronic content served by the system. The producer may note various details that indicate a type, nature, or other characteristic of the event (e.g., member identity or other member attribute, triggering action, identity of a content item involved in the action, a timestamp). The event producer may be a system component that only produces events, or it may also (e.g., at different times) be an event consumer or a broker.

In operation 204, the producer labels the event with the next event identifier in sequence. Thus, for a very first event (e.g., after the system or the service that comprises the producer begins execution), the corresponding identifier will be the first identifier of the first epoch of identifiers. Thereafter, the remaining identifiers of the first epoch are used in sequence, followed by the identifiers of the second epoch, and so on. After all epochs have been iterated, labeling repeats from the beginning.

The producer may also affix a timestamp to the event and/or include one or more suitable event characteristics, which may, for example, be used to deliver the event to interested event consumers. After the event is prepared, a message comprising or identifying the event is dispatched toward one or more consumers, or released for retrieval by one or more consumers. In this context, a broker may be treated as an event consumer, at least from the perspective of the producer of the event.

One of ordinary skill in the art will appreciate that “transmitting an event” and “transmitting a notification of an event” may be considered equivalent, along with similar phrases, for purposes of describing current embodiments. In other words, event producers, event consumers, and/or brokers may be considered to exchange events and/or notifications of events.

In operation 210, the event is received by an event consumer. The remainder of the illustrated process focuses upon ensuring that duplicate events and/or out-of-order events are identified and treated accordingly (e.g., by being discarded or used to initiate error recovery), and that all events received in order are handled in a timely manner. Because events are being produced and consumed continuously, at an extremely rapid rate, minimal processing can be spared for each individual event, and so it is desirable to be able to quickly identify out-of-order events.

In operation 212, the event consumer determines whether the identifier of the newly received event follows a previously received event (e.g., the previous event from the same producer, the previous event of the same type or division). This determination may entail checking whether the identifier of the new event is of the same epoch or a different epoch than the previous event. If it is of the same epoch, the determination involves checking whether the new identifier is greater than the previous identifier.

If the new identifier is of a different epoch, which may indicate that event identification/ordering has switched from one epoch to another, any valid identifier of another epoch may be accepted and assumed to follow the identifier of the previous event. As will be seen below, additional examination using other information that accompanies the event may be used to determine whether the newly received event is newer or more recent than the previously handled event.

In some implementations in which more than two epochs are employed, however, only an identifier of the epoch that follows the epoch of the previous identifier may be accepted as correctly following the previous identifier, in order to quickly screen out old and/or duplicate events or event notifications.

In short, operation 212 involves a rapid determination of whether the just-received event appears to be newer than the previously received event. If the new identifier does not follow the previous one, the illustrated method advances to operation 224; otherwise, the method proceeds to operation 214.

In operation 214, the event consumer further examines the event to determine whether the timestamp of the new event is greater than or equal to the timestamp of the previous event. Because of the very rapid pace of events, multiple events may have the same timestamp. Therefore, a newly received event that has the same timestamp as the previously processed event may be interpreted as having occurred simultaneous with, before, or after the previous event. For purposes of the presently discussed method, however, a new event having the same or a later timestamp than a previous timestamp is deemed to have occurred later in time than the previous event, particularly if its identifier follows the previous event's identifier.

If the timestamp of the new event is newer than or equal to the previous event, the illustrated method proceeds to operation 216; otherwise, the method advances to operation 224.

In operation 216, the new event has been determined to be newer or more recent than the last event that was received in the same stream of events. In particular, the new event is not from a previous epoch (or a previous iteration of the current epoch), and has a newer or greater identifier than the previous event.

In operation 220, the event consumer determines whether the new event is out of order. This may involve determining whether the identifier of the new event is the next expected identifier—either the next identifier in sequence in the same epoch as the previous event, or the first identifier in the next epoch if the previous event belonged to the previous epoch.

In some environments and circumstances, the next expected event may be delayed, corrupted, or lost in route, in which case the new event may have an identifier greater than or newer than what was expected. If the new event is out of order, the illustrated process advances to operation 224; otherwise, it proceeds to operation 222.

In operation 222, the new event is the next expected event, which should be the normal situation. The event is therefore processed normally, which may involve storing it or some data conveyed with the event, initiating a new follow-on event, updating stored data relating to an entity or action associated with the event, etc. After operation 222, the method ends.

In operation 224, the event consumer processes the old, duplicate, or out-of-order event in an appropriate manner. This processing may involve determining which situation applies (e.g., determining whether the new event is a duplicate or has been received out of order).

In some circumstances, such as if the new event is a duplicate of a previous event, the event may simply be discarded. If the new event is an old event—if the event has a timestamp older than the previous event and/or has an older/previous identifier—but is not a duplicate, it still may be discarded; alternatively, it may be processed like a new/current/expected event if doing so will not corrupt system data.

If the new event is newer than the event that was expected or due, it may be processed normally (as in operation 222) or may possibly be buffered or queued to be process after the expected event is received or is deemed lost.

In other embodiments, a process for enforcing or verifying correct ordering of events may entail the same or similar operations in a different order.

For example, in some alternative embodiments, an event consumer may first explicitly determine whether a newly received event (e.g., in a particular stream of events) is the next one expected, based on its associated epoch and/or identifier—that is, does the new event have the next identifier in sequence in the current epoch or does it have the first identifier in the next epoch (if the previous event had the final identifier of the previous epoch)? Further processing after that determination may involve handling a correctly received event or determining whether the new event is a duplicate event, an old event received out of order, or a new event received out of order.

In some other alternative embodiments, a new event's timestamp may be examined before its identifier (e.g., by reversing the order of operations 212, 214 of FIG. 2) to first screen out or identify old/duplicate events, and then determine whether the new event is the expected event.

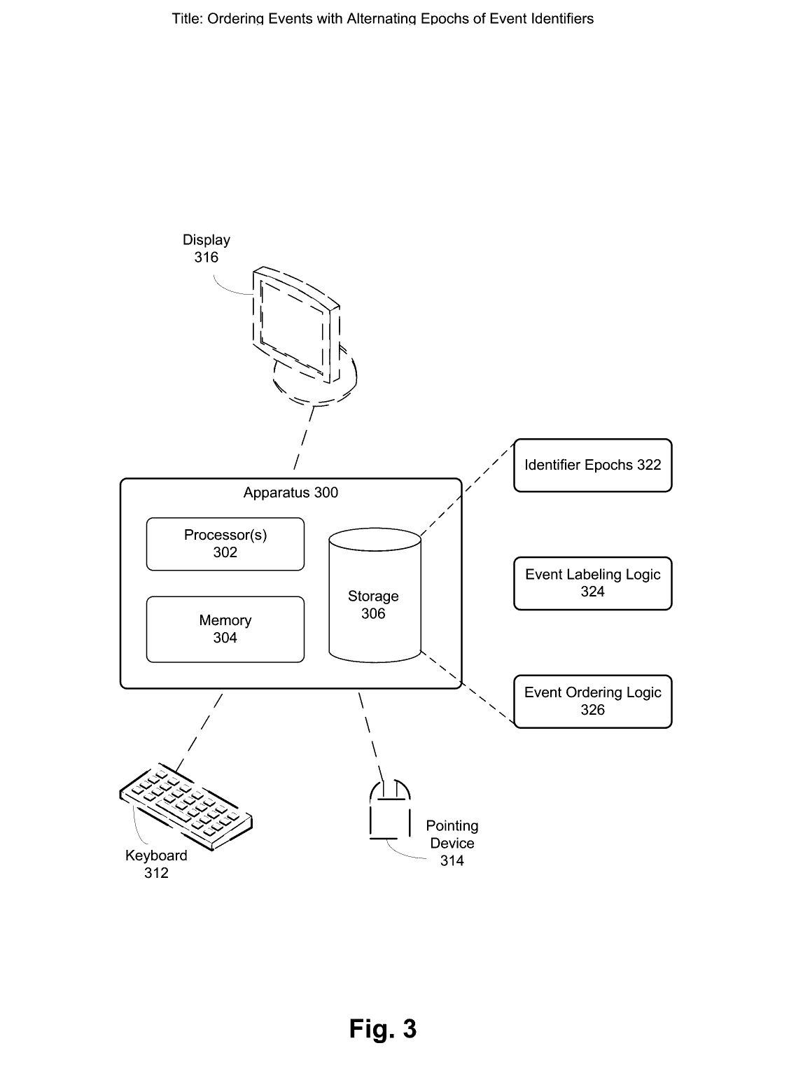

FIG. 3 is a block diagram of an apparatus that uses alternating epochs of identifiers to identify events within a computing environment, according to some embodiments.

Apparatus 300 of FIG. 3 includes processor(s) 302, memory 304, and storage 306, which may comprise one or more optical, solid-state, and/or magnetic storage components. Storage 306 may be local to or remote from the apparatus. Apparatus 300 can be coupled (permanently or temporarily) to keyboard 312, pointing device 314, and display 316.

In some environments or situations, apparatus 300 may be configured and capable of being any or all of an event producer, an event consumer, and a broker. Thus, the apparatus is configured with hardware and software for applying alternating epochs of identifiers to identify events at a rapid pace, for verifying or ordering events based on their identifiers and/or other information (e.g., timestamps, event characteristics, attributes of a member or system component involved in the event), and/or for making events available to event consumers. In other embodiments, apparatus 300 is configured to perform only one role (e.g., event producer, event consumer, or broker).

Storage 306 stores identifier epochs 322, which include data identifying multiple epochs and, for each epoch, data that includes or identifies a sequence of (increasing or decreasing) identifiers that are mutually exclusive with other epochs' identifiers. When identifier epochs 322 are in use by apparatus 300, one or more pointers or other references may be maintained (e.g., in memory 304) to identify the previous, current, and/or next event identifier and/or epoch. Thus, each time an event producer uses a current (or next) identifier to label an event, and/or an event consumer processes a received event, epochs 322 and/or ancillary data (e.g., the pointers or other references) may be updated.

Storage 306 also stores logic that may be loaded into memory 304 for execution by processor(s) 302. Such logic includes event labeling logic 324 and event ordering logic 326. In other embodiments, a logic module may be divided to separate its functionality as desired, or multiple logic modules may be combined or merged.

Event labeling logic 324 comprises processor-executable instructions for applying identifier epochs 322 (by an event producer) to label new events. Logic 324 may also comprise instructions for labeling events (or event notifications) with other information, as described above. Thus, event labeling logic 324 may be executed whenever apparatus 300 observes or is informed of an action or activity that meets criteria for initiating a new event; these criteria may be part of logic 324 or may be separate.

Event ordering logic 326 comprises processor-executable instructions for examining and/or ordering new events received at an event consumer (or possibly a broker). Logic 326 may therefore serve to determine whether a new event has been received in order or out of order, whether it pre-dates or post-dates a previously received event, whether it matches a particular event type (e.g., a type of event to which a consumer or broker subscribes), whether it is a duplicate, etc. Logic 326 may also, or instead, include instructions for acting as a broker by delivering events, or otherwise making them available (e.g., for retrieval), to event consumers.

In some embodiments, apparatus 300 includes other logic for handling or processing events, which, as described above, may involve triggering another event (possibly after performing some data manipulation); creating, storing, or transforming data based on the event (e.g., member attributes or characteristics that accompany the event); executing other logic dependent on the event; etc.

In some implementations, apparatus 300 performs some or all of the functions ascribed to one or more components of system 110 of FIG. 1.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method, comprising:
at an event producer within a computing environment hosting an online application:
initiating a new event in response to application activity; and
labeling the new event with a current event identifier of a first epoch comprising a first sequence of event identifiers;
wherein the event producer labels events within the online application with event identifiers from multiple alternating epochs that include the first epoch and a second epoch comprising a second sequence of event identifiers mutually exclusive of the first sequence; and
at an event consumer within the computing environment:
receiving the new event; and
determining whether the new event was received out of order.

2. The method of claim 1, wherein determining whether the new event was received out of order comprises:
comparing the current event identifier to a previous event identifier of a previously received event;
comparing a timestamp of the new event to a previous timestamp of the previously received event;
based on the current event identifier, identifying the first epoch; and
based on the previous event identifier, identifying a previous epoch associated with the previously received event.

3. The method of claim 2, wherein determining whether the new event was received out of order further comprises:
comparing the first epoch with the previous epoch; and
when the first epoch does not match the previous epoch, determining one or more of:
whether the current event identifier is the first event identifier in the first sequence of event identifiers; and
whether the previous event identifier is the final event identifier in a sequence of event identifiers associated with the previous epoch.

4. The method of claim 1, wherein labeling the new event comprises:
retrieving data identifying a previous event identifier of an event preceding the new event;
identifying the first epoch as a current epoch among the multiple epochs; and
identifying the current event identifier.

5. The method of claim 4, wherein identifying the first epoch as the current epoch comprises one or more of:
identifying an epoch comprising the previous event identifier; and
determining whether the previous event identifier was the final event identifier in one of the multiple epochs' sequences of event identifiers.

6. The method of claim 1, wherein initiating the new event comprises:
detecting a predefined interaction between the computing environment and a user of the online application; and
associating a current timestamp with the new event.

7. The method of claim 6, further comprising:
associating one or more attributes of the user with the new event.

8. The method of claim 1, wherein event producers within the computing environment, including the event producer, initiate in excess of one hundred million events per minute.

9. An apparatus, comprising:
one or more processors; and
a first memory storing instructions that, when executed, cause the apparatus to:
initiate a new event in response to application activity; and
label the new event with a current event identifier of a first epoch comprising a first sequence of event identifiers;
wherein the event producer labels events within the online application with event identifiers from multiple alternating epochs that include the first epoch and a second epoch comprising a second sequence of event identifiers mutually exclusive of the first sequence; and
a second memory storing instructions that, when executed, cause the apparatus to:
receive the new event; and
determine whether the new event was received out of order.

10. The apparatus of claim 9, wherein determining whether the new event was received out of order comprises two or more of:
comparing the current event identifier to a previous event identifier of a previously received event;
comparing a timestamp of the new event to a previous timestamp of the previously received event;
based on the current event identifier, identifying the first epoch; and
based on the previous event identifier, identifying a previous epoch associated with the previously received event.

11. The apparatus of claim 10, wherein determining whether the new event was received out of order further comprises:
comparing the first epoch with the previous epoch; and
when the first epoch does not match the previous epoch, determining one or more of:
whether the current event identifier is the first event identifier in the first sequence of event identifiers; and
whether the previous event identifier is the final event identifier in a sequence of event identifiers associated with the previous epoch.

12. The apparatus of claim 9, wherein labeling the new event comprises:
retrieving data identifying a previous event identifier of an event preceding the new event;
identifying the first epoch as a current epoch among the multiple epochs; and
identifying the current event identifier.

13. The apparatus of claim 12, wherein identifying the first epoch as the current epoch comprises one or more of:
identifying an epoch comprising the previous event identifier; and
determining whether the previous event identifier was the final event identifier in one of the multiple epochs' sequences of event identifiers.

14. The apparatus of claim 9, wherein initiating the new event comprises:
detecting a predefined interaction between the computing environment and a user of the online application; and
associating a current timestamp with the new event.

15. A system, comprising:
one or more processors; and
an event producer module comprising a non-transitory computer-readable medium storing instructions that, when executed, cause the system to:
initiate a new event in response to application activity; and
label the new event with a current event identifier of a first epoch comprising a first sequence of event identifiers;
wherein the event producer labels events within the online application with event identifiers from multiple alternating epochs that include the first epoch and a second epoch comprising a second sequence of event identifiers mutually exclusive of the first sequence; and
an event consumer module comprising a non-transitory computer-readable medium storing instructions that, when executed, cause the system to:
receive the new event; and
determine whether the new event was received out of order.

16. The system of claim 15, wherein determining whether the new event was received out of order comprises two or more of:
comparing the current event identifier to a previous event identifier of a previously received event;
comparing a timestamp of the new event to a previous timestamp of the previously received event;
based on the current event identifier, identifying the first epoch; and
based on the previous event identifier, identifying a previous epoch associated with the previously received event.

17. The system of claim 16, wherein determining whether the new event was received out of order further comprises:
comparing the first epoch with the previous epoch; and
when the first epoch does not match the previous epoch, determining one or more of:
whether the current event identifier is the first event identifier in the first sequence of event identifiers; and
whether the previous event identifier is the final event identifier in a sequence of event identifiers associated with the previous epoch.

18. The system of claim 15, wherein labeling the new event comprises:
retrieving data identifying a previous event identifier of an event preceding the new event;
identifying the first epoch as a current epoch among the multiple epochs; and
identifying the current event identifier.

19. The system of claim 18, wherein identifying the first epoch as the current epoch comprises one or more of:
identifying an epoch comprising the previous event identifier; and
determining whether the previous event identifier was the final event identifier in one of the multiple epochs' sequences of event identifiers.

20. The system of claim 15, wherein initiating the new event comprises:
detecting a predefined interaction between the computing environment and a user of the online application; and
associating a current timestamp with the new event.
